(19) United States
(12) Patent Application Publication
(10) Pub. No.: US 2015/0262202 A1
(43) Pub. Date: Sep. 17, 2015

(54) System and Method for Visualizing Real Estate Markets

(71) Applicant: Jones Lang LaSalle IP, Inc., Chicago, IL (US)

(72) Inventors: Rosemary Feenan, London (GB); Jeremy Kelly, London (GB); Maria Popova, London (GB)

(73) Assignee: JONES LANG LASALLE IP, INC., Chicago, IL (US)

(21) Appl. No.: 14/644,948

(22) Filed: Mar. 11, 2015

Related U.S. Application Data
(60) Provisional application No. 61/951,377, filed on Mar. 11, 2014.

(51) Int. Cl. G06Q 30/02; G06T 11/20

(52) U.S. Cl. CPC G06Q 30/0201; G06T 11/206; G06Q 50/16

(57) ABSTRACT

A computer-system and method for visualizing real estate markets is described. In one embodiment, the method may include: obtaining raw real estate data from one or more public or proprietary data sources; classifying the raw real estate data based on at least one data type classification and at least one geographic classification to provide classified raw real estate data; normalizing the classified raw real estate data based on a mean value of the classified raw real estate data within one or more classifications to provide normalized real estate data; ranking a plurality of real estate markets based on the normalized real estate data to provide ranked real estate market data; and generating one or more real estate visualizations based on the ranked real estate market data.

### CROSS-REFERENCE TO RELATED APPLICATION AND PRIORITY CLAIM

This application is related to and claims priority to U.S. Provisional Patent Application No. 61/951,377 sharing the same title, which application is hereby incorporated by reference herein in its entirety.

### FIELD

This disclosure relates generally to computer systems for data management and manipulation for enhancing information assessment. More specifically, this disclosure relates to the field of computer-assisted visualizations of complex real estate market data.

### BACKGROUND

Sophisticated real estate players manage and invest in properties globally. However, the global real estate market includes millions of properties and hundreds of millions of square feet of available space. The picture is further complicated by differing currencies, governments, legal environments, business cultures, and economic opportunities. The vast quantity of data and multitude of variables make it difficult for individual real estate players (developers, investors, and occupiers) or institutions to make informed decisions.

There is a vast and growing amount of digital data on real estate property parameters and related financial data (e.g. interest rates, etc.). This data includes specific measures for most major cities, some of which is structured and the rest is unstructured (“big data”). Conventional technology is ill equipped to process, analyze, visualize, and make useful application of such structured and unstructured data. Some industry measures, such as the Case-Schiller Real Estate Index, are available for comparing various locations, but these compare only single variables and provide only limited insight into the markets. Accordingly, a computing-system and method is needed for enhanced data analysis of multiple real estate variables across multiple real estate markets.

### SUMMARY

To facilitate the analysis of an array of real estate variables across multiple real estate markets, a computer-implemented system and method are disclosed for processing, analyzing, and visualizing large amounts of real estate market data. The computerized determination and visualization approaches provided by the illustrative computer systems discussed herein offer a completely new and powerful methodology for interpreting large data sets. This gives users a unique perspective on real estate and economic trends, making it easier to track emerging market dynamics, identify opportunities, and visualize a city's position within the global framework. The data feeds include both raw financial market data (on pricing, etc.), and processed/derived indices reflecting market conditions such as relative market strength, dynamics, trends, valuations, etc. The computerized visualization systems described herein flexibly permit users to view, analyze, and interpret large data sets so that property managers and investors can make optimal decisions in reduced timeframes.

An illustrative embodiment of the advanced real estate data management computing-system comprises a data-collection module, a data-normalizing module, a ranking module, a normalized database, and a visualization module. This illustrative system is configured to collect raw data about real estate markets, classify the data, normalize the data, rank specific real estate markets based on the normalized data, and generate visualizations of the rankings and normalized data. The data may be classified, for example, according to specific geographic real estate markets and/or various market indicators. The visualizations may, for example, comprise a cluster of “bubbles” or a “sunburst”; that is, visual aids for data interpretation.

In one exemplary embodiment, the method described herein includes collecting raw data about real estate markets, classifying the data, normalizing the data, ranking specific real estate markets based on the classified and normalized data, and generating visualizations of the ranked and normalized data.

In another exemplary embodiment, the method may include: obtaining raw real estate data from one or more public or proprietary data sources; classifying the raw real estate data based on at least one data type classification and at least one geographic classification to provide classified raw real estate data; normalizing the classified raw real estate data based on a mean value of the classified raw real estate data within one or more classifications to provide normalized real estate data; ranking a plurality of real estate markets based on the normalized real estate data to provide ranked real estate market data; and generating, for display on a display device, one or more real estate visualizations based on the ranked real estate market data.

In still another exemplary embodiment, the method may further include obtaining visualization information from a user and generating one or more new real estate visualizations based on the visualization information obtained from the user.

In one exemplary embodiment, normalizing the classified raw real estate data based on a mean value of the classified raw real estate data within one or more classifications includes normalizing a mean value of the classified raw real estate data within a particular classification to equal 1 and assigning data values for particular real estate markets above or below 1.

In another exemplary embodiment, ranking a plurality of real estate markets based on the normalized real estate data includes comparing a normalized real estate value associated with a first real estate market with a normalized real estate value associated with a second real estate market with regard to at least one data type classification. In another embodiment, the normalized real estate value associated with a first real estate market may also be compared with the normalized real estate value associated with the second real estate market with regard to a geographic classification.

In one example, the visualization information may include: (i) a requested type of visualization (e.g., a “bubble visualization” or a “sunburst visualization,” as described in additional detail below); (ii) one or more real estate markets to include as part of the one or more visualizations; and/or (iii) one or more classifications of normalized real estate data to visualize.

In another example, the requested type of visualization may include a bubble visualization including one or more clusters of bubbles. Each bubble included as part of the one or more clusters of bubbles may represent a particular real estate market (e.g., New York City). In one example, each bubble may have a particular size (i.e., diameter) based on, for example, a commercial attraction index rating associated with the real estate market represented by the bubble. In another example where each bubble has a particular size, at least one cluster of bubbles is organized such that smaller bubbles are disposed near a center of the at least one cluster and larger bubbles are disposed near a perimeter of the at least one cluster. In another example, each bubble may have a particular color based on, for example, gross domestic product (GDP) growth associated with the real estate market represented by the bubble.

In one example, the requested type of visualization may include a sunburst visualization including one or more concentric circles. Each of the one or more concentric circles may be divided circumferentially into a plurality of segments such that each segment of the plurality of segments represents a particular real estate market. In another example, each segment of the one or more concentric circles has a particular size, wherein the size of each segment is based on a commercial attraction index rating associated with the real estate market represented by the segment. In still another example, each segment of the one or more concentric circles has a particular color, wherein the color of each segment is based on a geographic region to which the real estate market represented by the segment belongs.

### BRIEF DESCRIPTION OF THE DRAWINGS

FIG. 1 is a block diagram of a computer system which can be used to implement the one embodiment of the method or system, in accordance with the disclosure.

FIG. 2 is a block diagram illustrating functional modules of one embodiment of the system, in accordance with the disclosure, which shows the relationship between the modules, the data sources, and the user.

FIG. 3 is a flow chart illustrating one embodiment of the method, in accordance with the disclosure, showing steps of the method for visualizing real estate markets.

FIG. 4. illustrates a graphical user interface (GUI) including a “sunburst” visualization of real estate markets, classified according to global region, nation, and individual market and ranked in each classification according to normalized commercial attraction index, in accordance with one embodiment of the disclosure.

FIG. 5. illustrates a GUI including a “sunburst” visualization of real estate markets, classified according to global region, nation, and individual market and ranked in each classification according to normalized real estate investment, in accordance with one embodiment of the disclosure.

FIG. 6. illustrates a GUI including a “sunburst” visualization of real estate markets, classified according to global region, nation, and individual market and ranked in each classification according to normalized cross-border real estate investment, in accordance with one embodiment of the disclosure.

FIG. 7. illustrates a GUI including a “sunburst” visualization of real estate markets, classified according to global region, nation, and individual market and ranked in each classification according to economic size, in accordance with one embodiment of the disclosure.

FIG. 8. illustrates a GUI including a “bubble” visualization of real estate markets, ranked according to normalized commercial attraction index and Gross Domestic Product (GDP) growth, in accordance with one embodiment of the disclosure.

FIG. 9. illustrates a GUI including a “bubble” visualization of real estate markets, classified according to global region and ranked according to normalized commercial attraction index and Gross Domestic Product (GDP) growth, in accordance with one embodiment of the disclosure.

FIG. 10. illustrates a GUI including a “bubble” visualization of real estate markets, classified according to some exemplary global sub-regions and ranked according to normalized commercial attraction index and Gross Domestic Product (GDP) growth, in accordance with one embodiment of the disclosure.

FIG. 11. illustrates a GUI including a “bubble” visualization of real estate markets, classified according to some exemplary categories of real estate market maturity and ranked according to normalized commercial attraction index and Gross Domestic Product (GDP) growth, in accordance with one embodiment of the disclosure.

FIG. 12. illustrates a GUI including a “bubble” visualization of real estate markets, classified according to some exemplary categories of a real estate transparency index and ranked according to normalized commercial attraction index and Gross Domestic Product (GDP) growth, in accordance with one embodiment of the disclosure.

### DETAILED DESCRIPTION

To facilitate easy comparison of multiple real estate variables across multiple real estate markets, a computer-implemented system and method are disclosed for analyzing and visualizing real estate market data.

The system includes a data-collection module, a data-normalizing module, a ranking module, a normalized database, and a visualization module. These modules comprise logical elements and may be implemented in software, in hardware, or in both. The system is configured to collect raw data about real estate markets (referred to as “raw real estate data” herein), classify the data, normalize the data, rank specific real estate markets based on the normalized data, and display visualizations of the ranked and normalized data. The data may be classified, for example, according to specific geographic real estate markets and/or various market indicators. The visualizations may, for example, comprise a cluster of “bubbles” or a “sunburst.”

In one embodiment, the raw real estate data is collected from plurality of sources. These sources may be public or proprietary. The raw real estate data may include some analysis previously performed by the source or it may lack prior analysis. The data-collection module is configured to obtain the raw real estate data, classify it, and store it. The data-collection module may also store classified raw real estate data (i.e., raw real estate data that has been classified according to one or more classifications, which classifications may also be stored within the data collection module itself, or in any other suitable location accessible by the data-collection module via wired or wireless communication). Obtaining the raw real estate data may entail passively receiving it, actively requesting it, or any other method of obtaining the raw real estate data known to those having ordinary skill in the art.

In one embodiment, the raw real estate data is classified according to data type and geography. Geographic classifications of the raw real estate data may include, but are not limited to: the global region, global sub-region, global hemisphere, continent, nationality, national sub-region, states, provinces, prefectures, cities, neighborhoods, and postal or zip codes. Additionally, any level of geographic classification may further be designated as a real estate market. Classifications of the raw real estate data by data type may include, but are not limited to: economic size, economic growth, population, per capita economic size, per capita economic growth, amount of real estate investment, amount of cross-border real estate investment, a commercial attraction index, real estate market maturity, a real estate transparency index, the available stock of real estate, real estate rental rates, airport passenger volume, country risk index, or corporate presence index.

As a further example, a commercial attraction index may be based on a weighted model of population, air connectivity, corporate presence, commercial real estate stock, and investment volumes. Real estate market maturity may, for example, be based on a real estate market's real estate liquidity, transparency, and the quality and depth of its commercial stock and corporate profile. The real estate transparency index may, for example, be based on market data availability, market fundamentals, corporate governance, regulation, land and property registration procedures, sales transaction processes, real estate services, and other factors recognized by those having ordinary skill in the art.

In one embodiment, the data-normalizing module normalizes the classified raw real estate data based on the mean value of the data within one or more classifications. Normalizing the data enables compilation, analysis, and comparison of data, for example, from different markets, in different currencies, and in different classes of data. Many different techniques of normalizing the classified real estate data may be used. For example, in one embodiment, the mean value of that data in a given class may be normalized to equal 1. Data values for individual real estate markets would then be assigned values above or below 1, in which the ratio of the normalized market value to 1 is equal to the ratio of the raw data for that real estate market to the mean value of the class of data. By normalizing all classes to 1, classes of data can be easily compared, or combined to create an index.

In another embodiment, the median value of the data in a given class may be normalized to equal 1. In another embodiment, the mode of the data in a given class may be normalized to equal 1. In another embodiment, the data values for individual real estate markets may be assigned based on a nonlinear ratio to the mean, median, or mode of the raw data within the classification. In another embodiment, the classified raw real estate data may be normalized by converting raw values to a common base value. For example, values in foreign currencies may be converted to US dollars. A person having ordinary skill in the art will understand that the normalization techniques described above are not exhaustive and may be combined as required to provide useful data.

Aside from the exemplary embodiment or normalization described above, one skilled in the art will recognize that there are many other methods of normalizing the classified raw real estate data to facilitate compilation, analysis, and comparison of data.

In one embodiment, the ranking module ranks individual real estate markets according to their normalized values in one or more classes of data. The normalized database may be configured to store both the normalized real estate data and the rankings. For the purposes of this description, the term “database” is not meant to limit the meaning of the normalized database to any particular structure. The normalized database may be structured as one database in software, one memory location or storage device, multiple software databases, multiple memory locations or storage devices, or any equivalent arrangement that stores the information, indexes it, and facilitates searching and record retrieval.

In a further embodiment, the visualization module may obtain visualization information from a user, and ranking information and normalized data from the ranking module and/or the normalized database. The visualization module may generate one or more visualizations of the ranking information, the normalized data, or both (collectively, referred to as the “real estate visualizations” herein), based on the user's visualization information.

In one embodiment, the user's visualization information may include a requested type of visualization, one or more real estate markets to include in the visualization, and one or more classes of data to visualize. The types of visualization may comprise one or more clusters of “bubbles,” a “sunburst,” or other appropriate visualizations.

In one embodiment, the one or more clusters of bubbles may comprise a plurality of circles, with or without colored borders and with or without colored interiors. The individual circles in the plurality of circles each represent one real estate market. In another embodiment, the size of the circles may be based on the normalized data, in one or more classes of data, corresponding to the real estate market that circle represents. In another embodiment, the size of the circles may be based on the ranking, in one or more classes of data. In another embodiment, the color of the circles may be based on the normalized real estate data, in one or more classes of data, corresponding to the real estate market that each circle represents. In another embodiment, the color of the circles may be based on the ranking, in one or more classes of data, of the real estate market that each circle represents. In another embodiment, the color of the circles' borders may be based on the normalized real estate data, in one or more classes of data, corresponding to the real estate market that each circle represents. In another embodiment, the color of the circles' may be based on the ranking, in one or more classes of data, of the real estate market that each circle represents.

In another embodiment, the visualization information obtained from the user may include highlighting, via an interface, one or more individual circles. The interface may be a graphical user interface (GUI), as is known in the art. In such an embodiment, the one or more highlighted circles may remain highlighted as the user requests different visualizations. This enables the user, for example, to easily keep track of particular real estate markets as she researches different classes of real estate market data.

In another embodiment, the clusters of circles may be organized, automatically, according to size. For example, the clusters may be organized such that smaller circles are in the center of the cluster and larger circles are located on the perimeter of the cluster. This may, for example, make more important real estate markets, in that class of data, easier to identify. In another embodiment, some or all of the circles may be labeled with the name of the real estate market they represent.

In another embodiment, the user may select one or more circles and cause the visualization to display raw real estate data, normalized real estate data, or ranking information associated with the one or more real estate markets corresponding to the one or more circles selected. The selection may be transient, for example, by “hovering” over the circle using, e.g., a cursor in a GUI. In another embodiment, the selection may also be temporary, as where the circle may be highlighted or de-highlighted by clicking on it in the GUI (e.g., via the use of a cursor). In another embodiment, the user may select the one or more circles by typing, into a text field, all or a part of the name of the real estate market corresponding to the circle to be selected.

In another embodiment, the visualization may comprise a “sunburst”, in which a “sunburst” comprises one or more concentric circles, in which the one or more concentric circles are each divided circumferentially into a plurality of segments, in which each segment corresponds to a particular real estate market. In one embodiment, the size of the segments may be based on the normalized real estate data, in one or more classes of data, corresponding to the real estate market that segment represents. In another embodiment, the order of the segments may be based on the ranking, in one or more classes of data, of the real estate market that segment represents. In another embodiment, the size of the segments may be based on the ranking, in one or more classes of data, of the real estate market that segment represents. In another embodiment, the color of the segments may be based on the normalized real estate data, in one or more classes of data, corresponding to the real estate market that each segment represents. In another embodiment, the color of the segments may be based on the ranking, in one or more classes of data, of the real estate market that each segment represents. In another embodiment, the color of the segments' borders may be based on the normalized real estate data, in one or more classes of data, corresponding to the real estate market that each segment represents. In another embodiment, the color of the segments' borders may be based on the ranking, in one or more classes of data, of the real estate market that each segment represents. In another embodiment, the color of the segments may correspond to another, geographically larger real estate market. For example, all of the segments representing real estate markets within North America may be the same color.

In some embodiments, the visualizations may be generated using commonly available software tools for generating data visualizations known in the art. One example of such software tools would be the “D3” open-source code library available at http://D3js.org, which is hereby incorporated by reference. Other software or hardware tools may similarly be utilized to generate the visualizations, as known in the art. Alternately, custom software or hardware may be utilized to generate the visualizations.

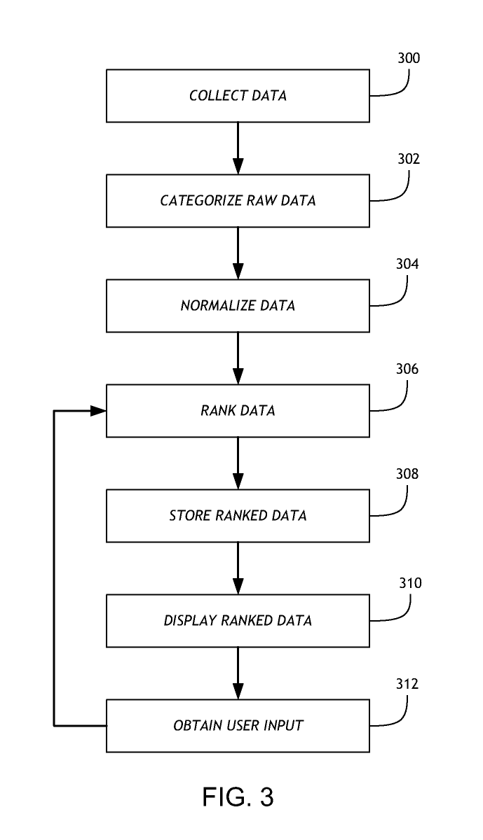

Another embodiment of the disclosure includes a method for visualizing real estate markets. The method may include collecting raw data about real estate markets (i.e., “raw real estate data”), classifying the raw real estate data to provide classified raw real estate data, normalizing the classified raw real estate data to provide normalized real estate data, ranking specific real estate markets based on the normalized real estate data to provide ranked real estate market data, and displaying visualizations of the ranked and normalized real estate data. The method is discussed in greater detail with regard to FIG. 3, below.

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

### Exemplary Applications of the Disclosure

Many potential applications exist for the instant disclosure. In one application, real estate professionals may use data regarding overall market conditions to counsel clients regarding real estate investments. For example, a client involved in retailing may be interested in locating new stores. A real estate professional may use the disclosure to assist the client in visualizing average sales for retailers, rents, or available floorspace in particular real estate markets. The client could also compare those real estate market considerations with measures of market size, such as population, GDP, and total retail sales. Such a comparative visualization may, for example, highlight that a particular real estate market has unusually high retail sales for its population.

In another potential application for the disclosure, the retailer itself may use the disclosure to visualize and compare individual store performance within a real estate market, or across real estate markets. Such a comparative visualization may, for example, highlight that the retailer has a particularly high store density in one real estate market. Another analysis might highlight that one store has disproportionately low floorspace for the local GDP per capita (and may therefore decide to increase its footprint in a particular location).

In another potential application of the instant disclosure, a corporation might, for example, use the disclosure to visualize its real estate portfolio on a global scale. The corporation could thus easily visualize its floorspace, employees, and vacant space on a global scale. Alternately, the corporation could contrast the same or similar factors according to global sub-region, real estate market maturity, or real estate market transparency.

These are merely examples, and one skilled in the art would recognize that there are many other potential applications for the instant disclosure.

### DETAILED DESCRIPTION OF THE FIGURES

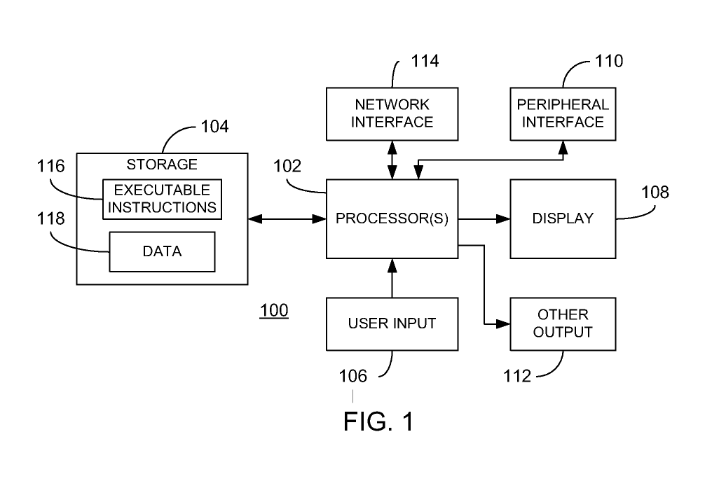

Referring now to the Figures, in which like reference numerals represent like parts, various embodiments of the computing devices and methods will be disclosed in detail. FIG. 1 is a block diagram illustrating one example of a computing device 100 suitable for use in generating real estate visualizations.

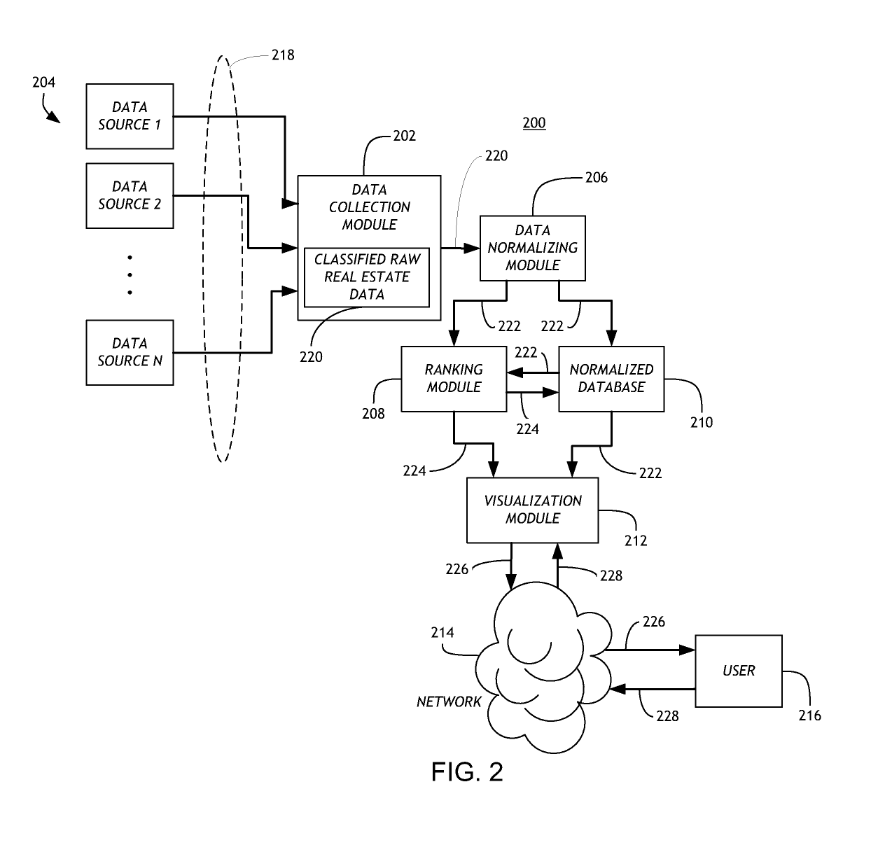

FIG. 1 illustrates a representative computing device 100 that may be used to implement the teachings of the instant disclosure. The device 100 may be used to implement, for example, one or more components of the system shown in FIG. 2, as described in greater detail below. The device 100 includes one or more processors 102 operatively connected to a storage component 104. The storage component 104, in turn, includes stored executable instructions 116 and data 118. In an embodiment, the processor(s) 102 may include one or more of a microprocessor, microcontroller, digital signal processor, co-processor or the like or combinations thereof capable of executing the stored instructions 116 and operating upon the stored data 118. Likewise, the storage component 104 may include one or more devices such as volatile or nonvolatile memory including but not limited to random access memory (RAM) or read only memory (ROM). Further still, the storage component 104 may be embodied in a variety of forms, such as a hard drive, optical disc drive, floppy disc drive, flash memory, etc. Processor and storage arrangements of the types illustrated in FIG. 1 are well known to those having ordinary skill in the art. In one embodiment, the processing techniques described herein are implemented as a combination of executable instructions and data within the storage component 104.

As shown, the computing device 100 may include one or more user input devices 106, a display 108, a peripheral interface 110, other output devices 112, and a network interface 114 in communication with the processor(s) 102. The user input device 106 may include any mechanism for providing user input to the processor(s) 102. For example, the user input device 106 may include a keyboard, a mouse, a touch screen, microphone and suitable voice recognition application, or any other means whereby a user of the device 100 may provide input data to the processor(s) 102. The display 108 may include any conventional display mechanism such as a cathode ray tube (CRT), flat panel display, or any other display mechanism known to those having ordinary skill in the art. In an embodiment, the display 108, in conjunction with suitable stored instructions 116, may be used to implement a graphical user interface. Implementation of a graphical user interface in this manner is well known to those having ordinary skill in the art. The peripheral interface 110 may include the hardware, firmware and/or software necessary for communication with various peripheral devices, such as media drives (e.g., magnetic disk or optical disk drives), other processing devices, or any other input source used in connection with the instant techniques. Likewise, the other output device(s) 112 may optionally include similar media drive mechanisms, other processing devices, or other output destinations capable of providing information to a user of the device 100, such as speakers, LEDs, tactile outputs, etc. Finally, the network interface 114 may include hardware, firmware, and/or software that allows the processor(s) 102 to communicate with other devices via wired or wireless networks, whether local or wide area, private or public, as known in the art. For example, such networks may include the World Wide Web or Internet, or private enterprise networks, as known in the art.

While the computing device 100 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the device 100 may include a greater or lesser number of components than those illustrated. Once again, those of ordinary skill in the art will appreciate the wide number of variations that may be used is this manner. Further still, although a single computing device 100 is illustrated in FIG. 1, it is understood that a combination of such computing devices may be configured to operate in conjunction (for example, using known networking techniques) to implement the teachings of the instant disclosure.

FIG. 2 is a block-diagram illustrating one embodiment of the disclosure, comprising a computer system 200 for visualizing real estate markets. The system 200 comprises a data-collection module 202, a data-normalizing module 206, a ranking module 208, a normalized database 210, and a visualization module 212. These modules 202, 206, 208, and 212 comprise logical elements and may be implemented in software, in hardware, or in both. The data-collection module 202 is operatively connected to a plurality of data sources 204 and the data-normalizing module 206. The data-normalizing module 206 is also operatively connected to the ranking module 208 and the normalized database 210. The ranking module 208 and the normalized database 210 are also operatively connected to each other. The visualization module 212 is operatively connected to the ranking module 208, the normalized database 210, and at least one user 216. Any of the operative connections may comprise wired or wireless connections including, for example, connections over a network such as the internet.

In operation, the data-collecting module 202 is configured to obtain raw real estate data 218 from the plurality of data source 204. The data-collecting module 202 is further configured to classify the raw real estate data 218 to provide classified raw real estate data 220, and to store the classified raw real estate data 220. Although the classified raw real estate data 220 is show in FIG. 2 as being stored in the data collection module 202, those having ordinary skill in the art will recognize that this data 220 may be stored in any suitable location (e.g., the normalized database 210) without deviating from the teachings of the instant disclosure. The data normalizing module 206 is configured to obtain the classified raw real estate data 220 from the data-collection module 202, to generate mean values of the classified raw real estate data, and to generate normalized real estate data 222 based, at least, on the mean values of the classified raw real estate data 220. The ranking module 208 is configured to obtain the normalized real estate data 222 from the data-normalizing module 206 and generate ranked real estate market data 224 based on the normalized real estate data 222. The normalized database 210 is configured to obtain and store normalized real estate data 222 from the data-normalizing module 206 and ranked real estate market data 224 from the ranking module 208.

The visualization module 212 is configured to obtain visualization information 228 from one or more users 216. This visualization information 228 may describe what class or classes of real estate data to visualize and/or which real estate markets to visualize. The visualization information 228 may also describe the type of visualization the user(s) 216 desire(s). For example, a user 216 may request, via the visualization information 228, for the visualization module 212 to generate a “sunburst” visualization of Commercial Attraction Index for the global top three-hundred real estate markets. The user 216 may provide further visualization information 228 to further customize or interact with this visualization by selecting, highlighting, or hovering over segments of the “sunburst.”

The visualization module 212 may also obtain normalized real estate data 222 from the data-normalizing module 206 and/or ranked real estate market data 224 from the ranking module 208 and generate the visualization. As the user 216 modifies or requests new visualizations, the visualization module 212 will continue to obtain new normalized real estate data 222 from the data-normalizing module 206 and ranked real estate market data 224 from the ranking module 208, as needed.

FIG. 3 is a flow chart illustrating one exemplary method for visualizing real estate markets in accordance with the instant disclosure. At step 300, raw real estate data is collected. At step 302, the raw real estate data is classified. At step 304, the classified raw real estate data is normalized. At step 306, the real estate markets are ranked based on the classified and normalized real estate data. At step 308, the ranked real estate market data is stored. At step 310, a visualization is generated, based on the ranked real estate market data and the normalized real estate data. At step 312, user input is obtained. The new user input may require a new ranking and visualization to be generated.

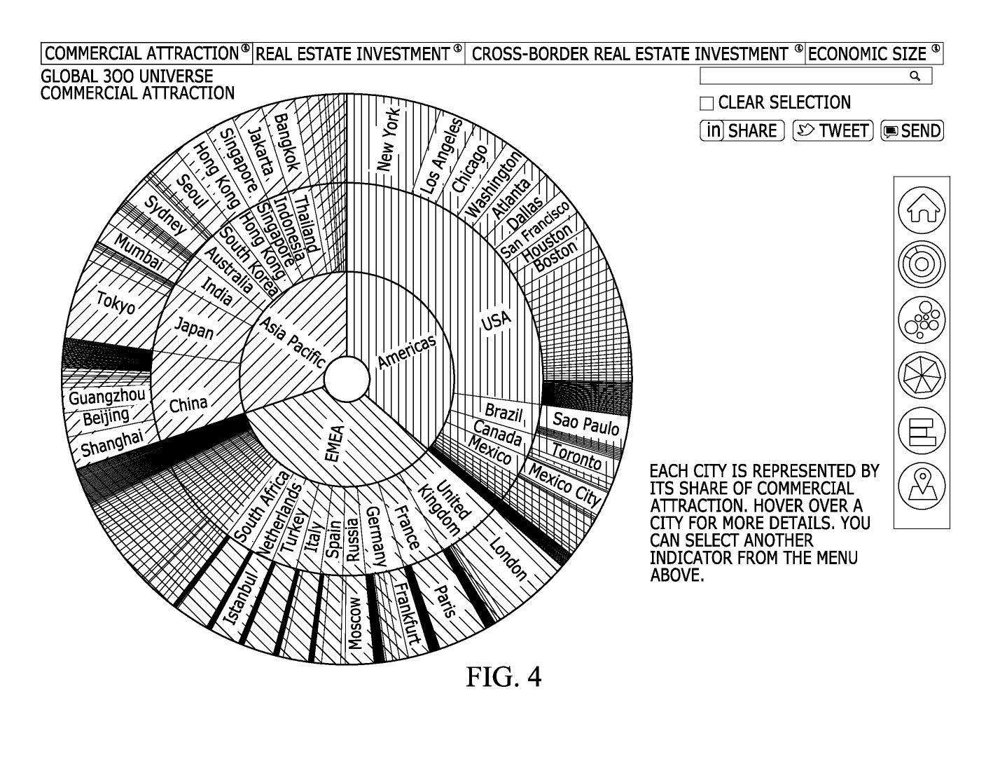

FIG. 4 illustrates a graphical user interface (GUI) including a “sunburst” visualization of the top three hundred real estate markets in the world. The individual markets are ranked according to their Commercial Attraction Index values and grouped according to their global region and nationality. The individual real estate markets are also colored according to their global region.

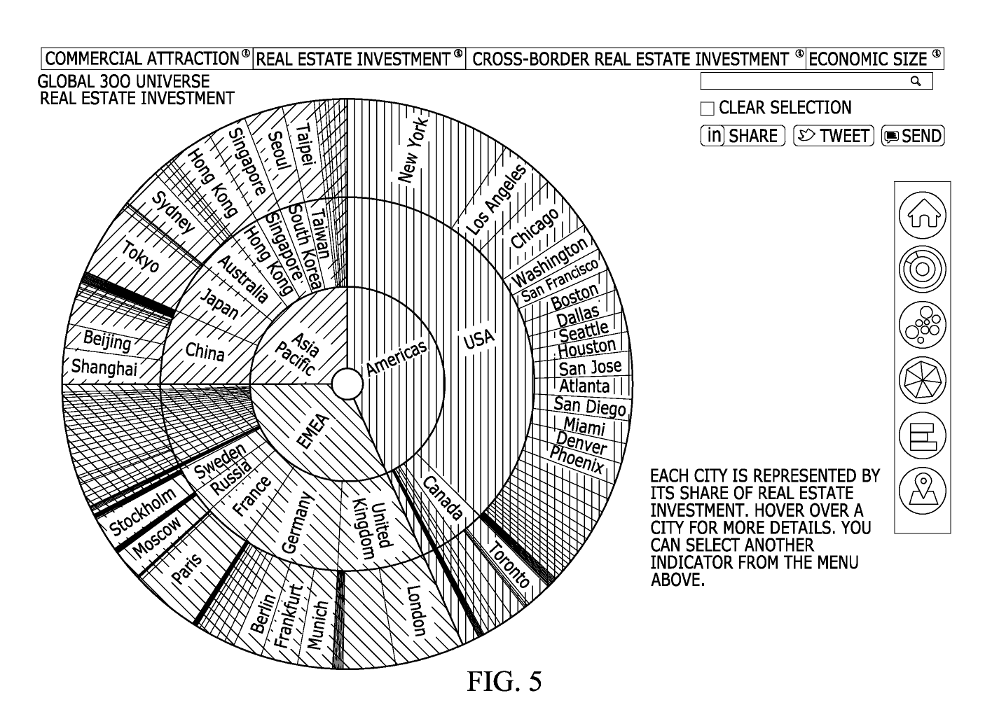

FIG. 5 illustrates a GUI including a “sunburst” visualization of the top three hundred real estate markets in the world. The individual markets are ranked according to their real estate investment values and grouped according to their global region and nationality. The individual real estate markets are also colored according to their global region.

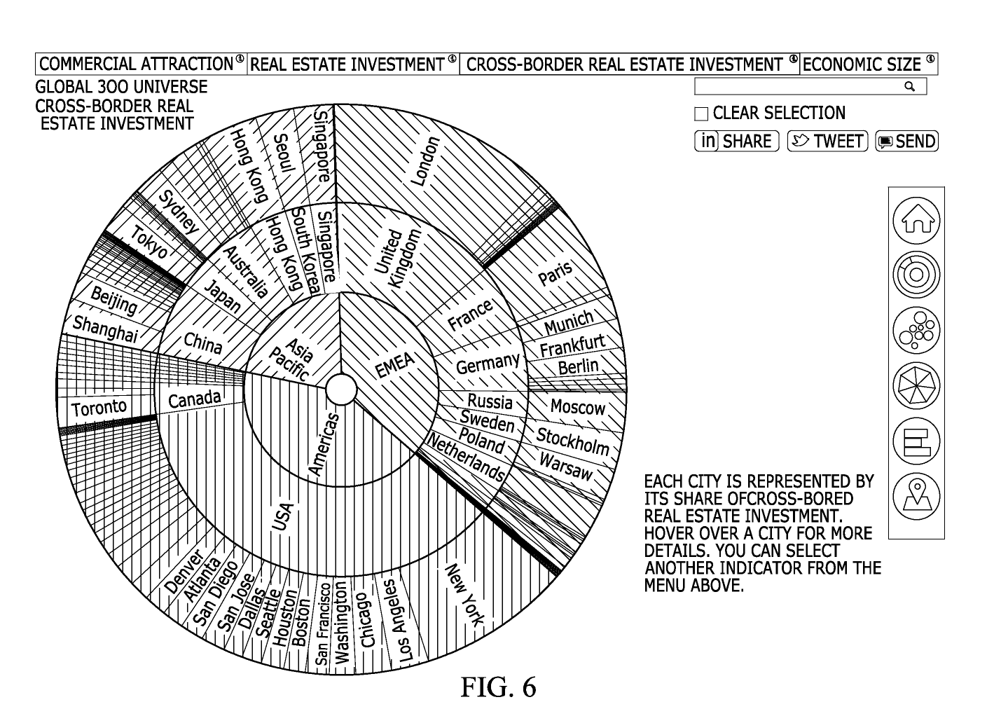

FIG. 6 illustrates a GUI including a “sunburst” visualization of the top three hundred real estate markets in the world. The individual markets are ranked according to their cross-border real estate investment values and grouped according to their global region and nationality. The individual real estate markets are also colored according to their global region.

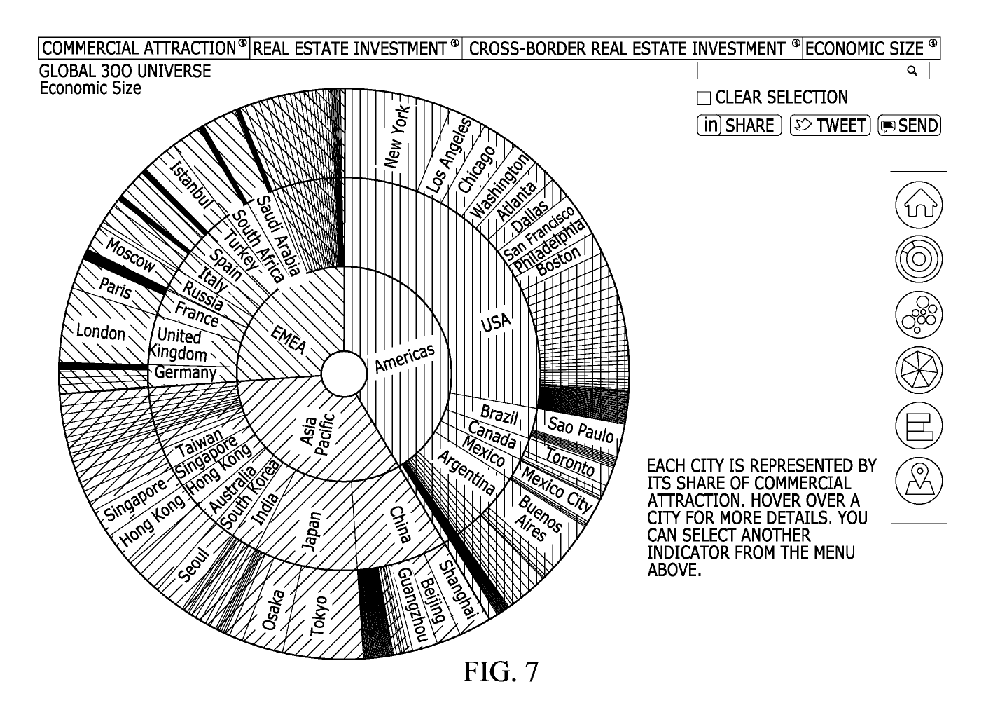

FIG. 7 illustrates a GUI including a “sunburst” visualization of the top three hundred real estate markets in the world. The bubbles for individual markets are sized according to their economic size values and grouped according to their global region and nationality. The bubbles for individual real estate markets are also colored according to their global region.

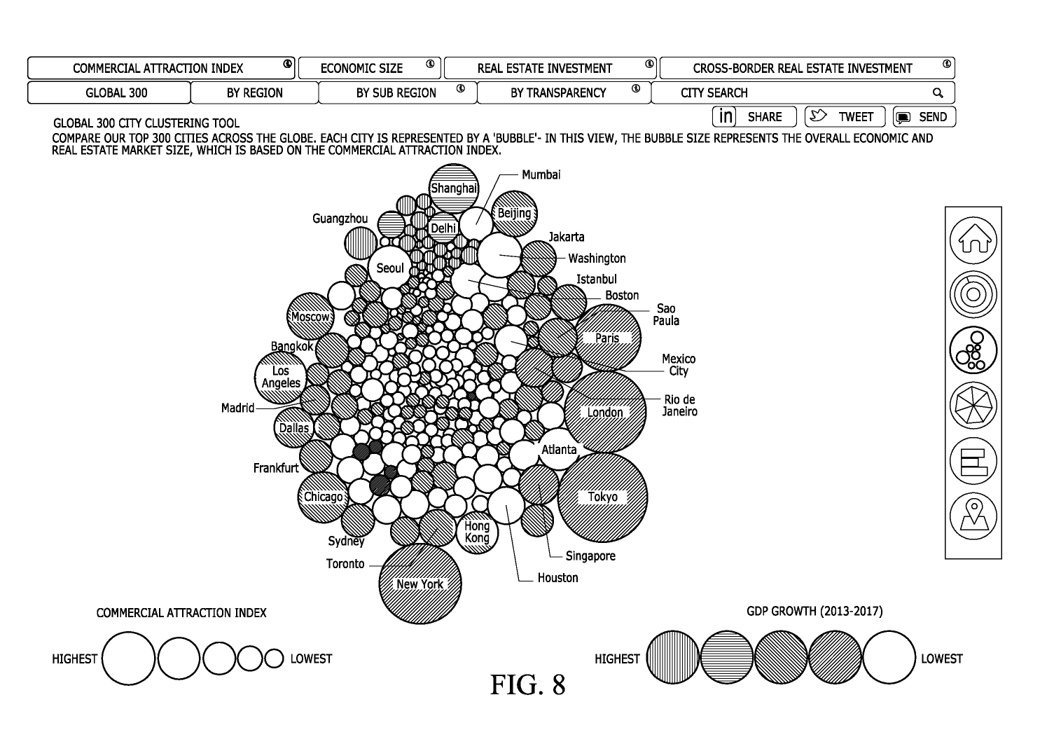

FIG. 8 illustrates a GUI including a “bubble” visualization of the top three hundred real estate markets in the world. The bubbles for individual markets are sized according to their Commercial Attraction Index values and grouped together. The bubbles for individual real estate markets are also colored according to their Gross Domestic Product (GDP) growth.

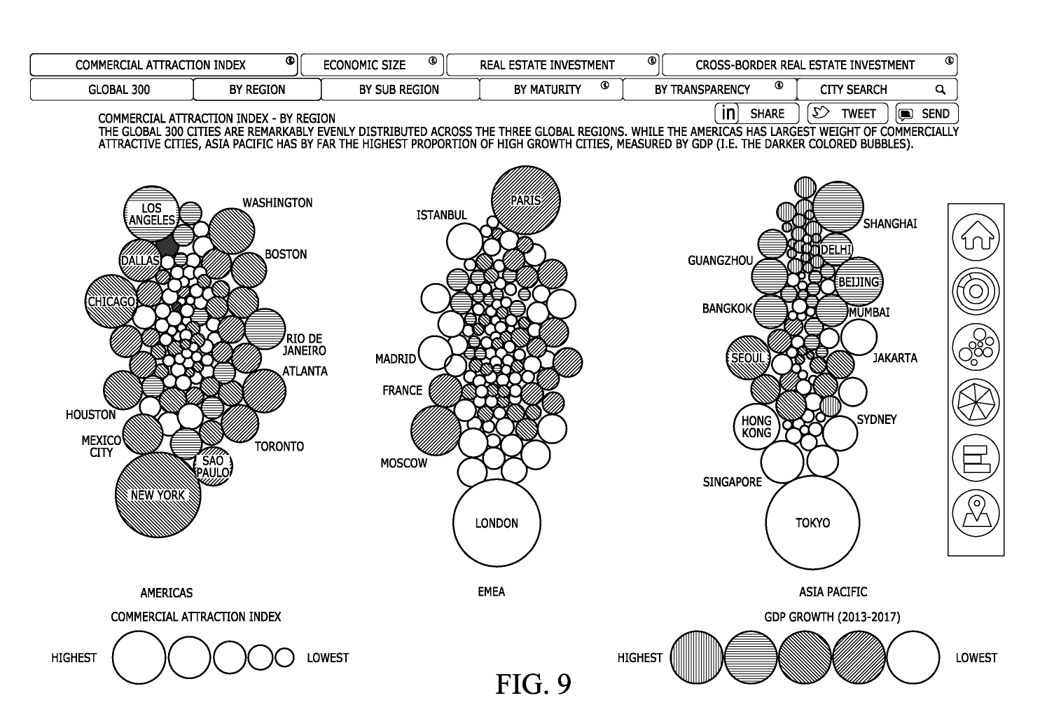

FIG. 9 illustrates a GUI including a “bubble” visualization of the top three hundred real estate markets in the world. The individual markets are ranked according to their Commercial Attraction Index values and grouped according to their global region. The individual real estate markets are also colored according to their GDP growth.

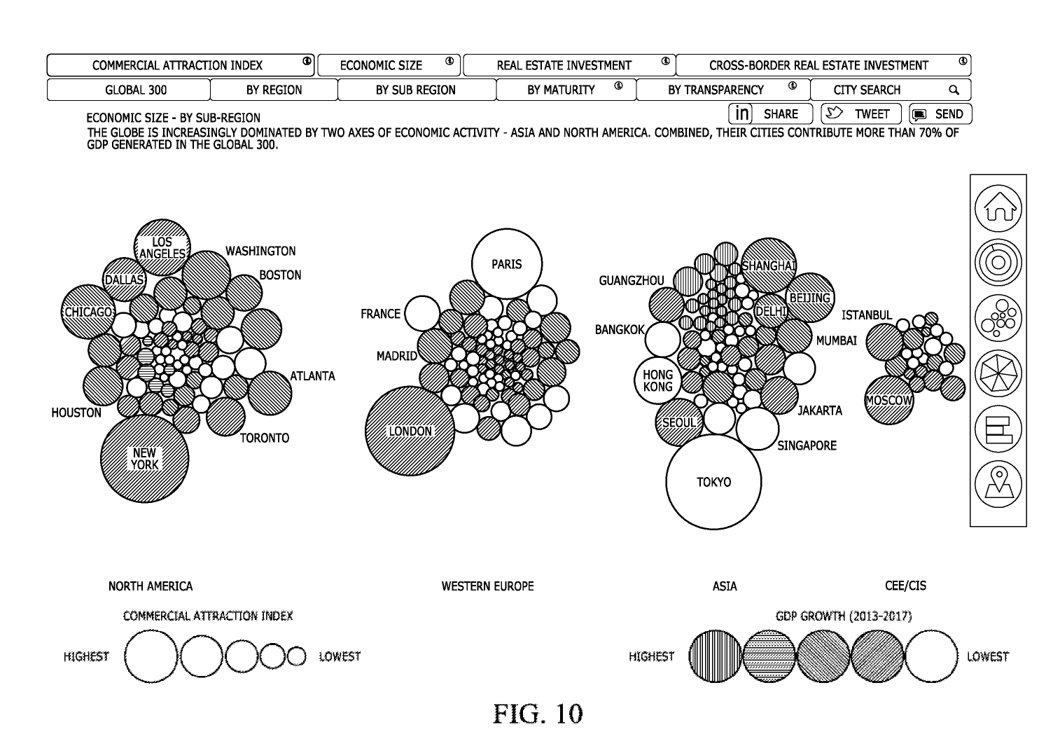

FIG. 10 illustrates a GUI including a “bubble” visualization of some of the top real estate markets in the world. The bubbles for individual markets are sized according to their Commercial Attraction Index values and grouped according to some exemplary global sub-regions. The figure shows real estate markets in the global sub-regions of North America, Western Europe, Asia, and Central and Eastern Europe and the Commonwealth of Independent States (i.e. the former Soviet republics). Other global sub-regions may include, for example, Latin America and the Caribbean, the Middle East and North Africa, Australia, and Sub-Saharan Africa. The bubbles for individual real estate markets are also colored according to their GDP growth.

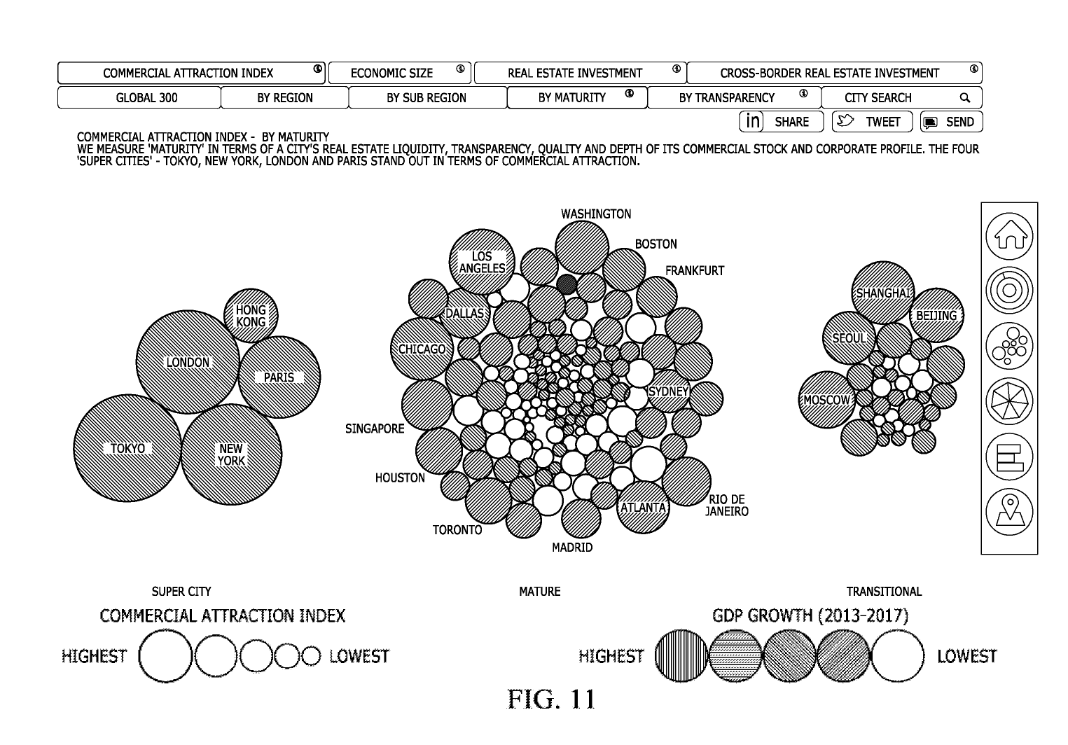

FIG. 11 illustrates a GUI including a “bubble” visualization of some of the top real estate markets in the world. The bubbles for individual markets are sized according to their Commercial Attraction Index values and grouped according to some exemplary categories of market maturity. The figure shows the market maturity categories of “Super Cities,” Mature markets, and Transitional markets. Other categories of market maturity may include, for example, Developing markets, Early Growth markets and Nascent markets. The bubbles for individual real estate markets are also colored according to their GDP growth.

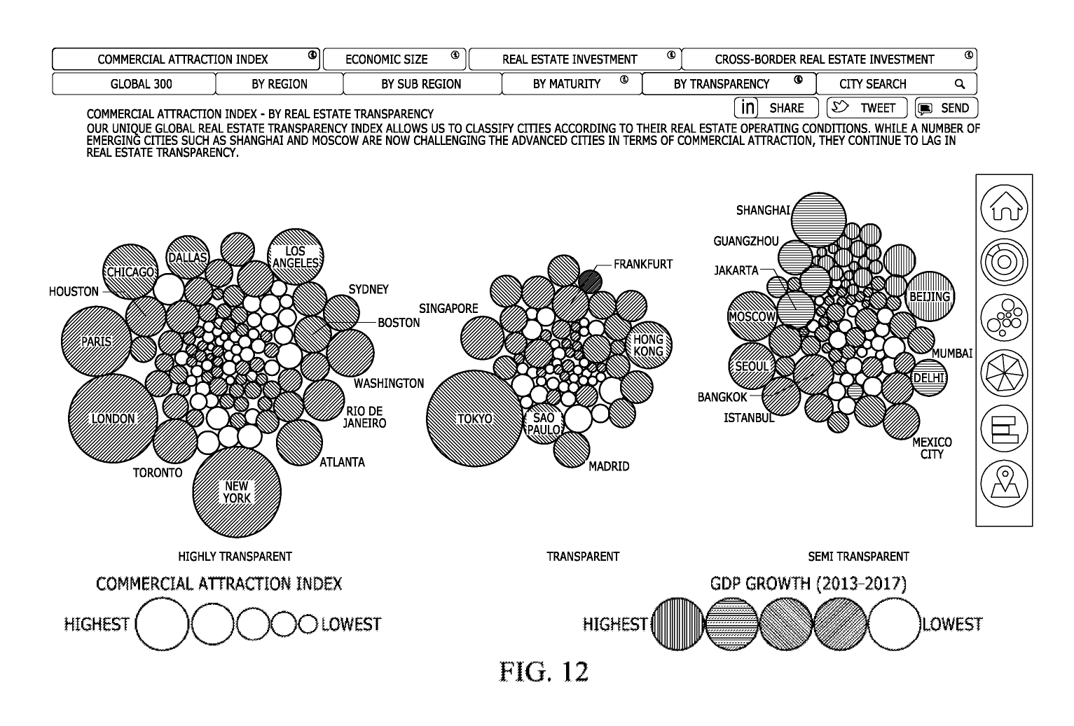

FIG. 12 illustrates a GUI including a “bubble” visualization of some of the top real estate markets in the world. The bubbles for individual markets are sized according to their Commercial Attraction Index values and grouped according to some exemplary categories for their real estate transparency index. The figure illustrates the real estate transparency categories of “Highly Transparent,” Transparent,” and “Semi Transparent.” Other real estate transparency categories may include, for example, “Low Transparency” and “Opaque.” The bubbles for individual real estate markets are also colored according to their GDP growth.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-system comprising:
memory comprising executable instructions; and
a processor operatively connected to the memory, the processor configured to execute the executable instructions in order to effectuate a method comprising:
obtaining raw real estate data from one or more public or proprietary data sources;
classifying the raw real estate data based on at least one data type classification and at least one geographic classification to provide classified raw real estate data;
normalizing the classified raw real estate data based on the classified raw real estate data within one or more data type classifications to provide normalized real estate data; and
generating, for display on a display device, one or more real estate visualizations based on the normalized real estate market data.

2. The computer-system of claim 1, wherein the processor is further configured to execute the executable instructions in order to effectuate the method further comprising:
obtaining visualization information from a user; and
generating new one or more real estate visualizations based on the visualization information.

3. The computer-system of claim 2, wherein the visualization information comprises at least one of the following:
a requested type of visualization;
one or more real estate markets to include as part of the one or more real estate visualizations; or
one or more classifications of the normalized real estate data to visualize.

4. The computer-system of claim 3, wherein the requested type of visualization comprises at least one of the following:
a bubble visualization comprising one or more clusters of bubbles, wherein each bubble included as part of the one or more clusters of bubbles represents a particular real estate market; or
a sunburst visualization comprising one or more concentric circles, wherein the one or more concentric circles are each divided circumferentially into a plurality of segments, and wherein each segment of the plurality of segments represents a particular real estate market.

5. The computer-system of claim 4, wherein each bubble comprises a particular size and wherein the size of each bubble is based on the normalized real estate data associated with the real estate market represented by the bubble within one or more of the one or more data type classifications.

6. The computer-system of claim 4, wherein each bubble comprises a particular color, and wherein the color of each bubble is based on the normalized real estate data associated with the real estate market represented by the bubble within one or more of the one or more data type classifications.

7. The computer-system of claim 4, wherein each bubble comprises a particular size, and wherein at least one cluster of bubbles is organized such that smaller bubbles are disposed near a center of the at least one cluster and larger bubbles are disposed near a perimeter of the at least one cluster.

8. The computer-system of claim 4, wherein each segment of the one or more concentric circles comprises a particular size, and wherein the size of each segment is based on the normalized real estate data associated with the real estate market represented by the segment within one or more of the one or more data type classifications.

9. The computer-system of claim 4, wherein each segment of the one or more concentric circles comprises a particular color, and wherein the color of each segment is based on a geographically larger real estate market to which the real estate market represented by the segment belongs.

10. The computer-system of claim 1, wherein the at least one data type classification comprises at least one of the following: economic size; economic growth; population; per capita economic size; per capita economic growth; an amount of real estate investment; an amount of cross-border real estate investment; a commercial attraction index; real estate market maturity; a real estate transparency index; an available stock of real estate; real estate rental rates; airport passenger volume; a country risk index; a corporate presence index; cost per square meter; market or population density; or service charges.

11. The computer-system of claim 1, wherein the at least one geographic classification comprises at least one of the following: global region; global sub-region; global hemisphere; continent; nationality; national sub-region; state; province; prefecture; city; neighborhood; postal code; or zip code.

12. The computer-system of claim 1, wherein normalizing the classified raw real estate data based on the classified raw real estate data within one or more data type classifications comprises:
setting a mean value of the classified raw real estate data within a particular classification to equal 1; and
assigning normalized data values for particular real estate markets above or below 1 based on:
the raw data value associated with the particular real estate markets within the particular classification; and
the mean value of the classified raw real estate data within the particular classification.

13. The computer-system of claim 1, wherein the processor is further configured to execute the executable instructions in order to effectuate the method further comprising:
ranking a plurality of real estate markets based on the normalized real estate data to provide ranked real estate market data and wherein ranking a plurality of real estate markets based on the normalized real estate data comprises:
comparing a normalized real estate value associated with a first real estate market with a normalized real estate value associated with a second real estate market with regard to at least one data type classification and a geographic classification.

14. A computer-implemented method comprising:
obtaining, by a processor, raw real estate data from one or more public or proprietary data sources;
classifying, by the processor, the raw real estate data based on at least one data type classification and at least one geographic classification to provide classified raw real estate data;
normalizing, by the processor, the classified raw real estate data based on the classified raw real estate data within the at least one data type classification to provide normalized real estate data; and
generating, by the processor and for display on a display device, one or more real estate visualizations based on the ranked real estate market data.

15. The computer-implemented method of claim 14, further comprising:
obtaining, by the processor, visualization information from a user; and
generating, by the processor, one or more new real estate visualizations based on the visualization information.

16. The computer-implemented method of claim 15, wherein the visualization information comprises at least one of the following:
a requested type of visualization;
one or more real estate markets to include as part of the one or more real estate visualizations; or
one or more classifications of the normalized real estate data to visualize.

17. The computer-implemented method of claim 16, wherein the requested type of visualization comprises at least one of the following:
a bubble visualization comprising one or more clusters of bubbles, wherein each bubble included as part of the one or more clusters of bubbles represents a particular real estate market; or
a sunburst visualization comprising one or more concentric circles, wherein the one or more concentric circles are each divided circumferentially into a plurality of segments, and wherein each segment of the plurality of segments represents a particular real estate market.

18. The computer-implemented method of claim 17, wherein each bubble comprises a particular size, and wherein the size of each bubble is based on the normalized real estate data associated with the real estate market represented by the bubble within the at least one data type classification.

19. The computer-implemented method of claim 17, wherein each bubble comprises a particular color, and wherein the color of each bubble is based on the normalized real estate data associated with the real estate market represented by the bubble within the at least one data type classification.

20. The computer-implemented method of claim 14, further comprising:
ranking, by the processor, a plurality of real estate markets based on the normalized real estate data to provide ranked real estate market data, wherein ranking a plurality of real estate markets based on the normalized real estate data comprises:
comparing a normalized real estate value associated with a first real estate market with a normalized real estate value associated with a second real estate market with regard to at least one data type classification and a geographic classification.
